(19) United States
(12) Patent Application Publication
(10) Pub. No.: US 2019/0347068 A1
(43) Pub. Date: Nov. 14, 2019

(54) PERSONAL HISTORY RECALL

(71) Applicant: Microsoft Technology Licensing, LLC, Redmond, WA (US)

(72) Inventors: Varun Khaitan, Seattle, WA (US); Nimit Acharya, Seattle, WA (US); Aman Saini, Seattle, WA (US); Nikhil Gupta, San Francisco, CA (US)

(21) Appl. No.: 15/976,152

(22) Filed: May 10, 2018

(51) Int. Cl. G06F 3/16; G10L 15/22; G06F 17/30

(52) U.S. Cl. CPC G06F 3/167; G10L 2015/223; G06F 17/30876; G10L 15/22

(57) ABSTRACT

Non-limiting examples of the present disclosure relate to personal history recall, for a received user input, through contextual analysis of user data associated with user usage of applications/services. Examples described herein extend functionality of and enable a virtual assistant to provide efficient and accurate recall processing even in instances where a user provides vague or general description. An exemplary virtual assistant is configured to process user input received through any modality. A virtual assistant is programmed with a skill for custom search processing that adapts operation of the virtual assistant. An exemplary skill for custom search processing provides a layer of intelligence over raw application data to enable the virtual assistant to match user input to a previous context in which a user was executing an application/service. Contextual search ranking and filtering factors in access to content and user activity when evaluating a user input such as a spoken utterance.

### BACKGROUND

Users commonly face situations where they have to recall a webpage, document, notes, etc., which they previously accessed. Typically, users are required to try to trace back their activity manually and remember specific details themselves. In most cases, the task of re-collection is primarily performed by a user manually going through his web history or by keeping relevant pages open. This is tedious, inefficient and becoming increasing challenging with the amount of data users access on a daily basis.

Applications such as web browsers may maintain a browser history. However, recall is limited to only the fixed uniform resource locator (URL), rather than recall of a specific context in which a user may have been searching content of that specific URL. As such, content recall can be improved from a technical standpoint. Technical shortcomings are further evident in recall instances involving digital speech assistants. More and more, users are relying on digital speech assistants in portable devices to assist with task execution. However, none of the speech assistants today help in recalling past seen web pages or other types of content.

### SUMMARY

In view of the foregoing technical shortcomings, non-limiting examples of the present disclosure relate to personal history recall, for a received user input, through contextual analysis of user data associated with user usage of applications/services. Examples described herein extend functionality of virtual assistant applications/services, enabling a virtual assistant service to provide efficient and accurate recall processing even in instances where a user provides vague or general description. An exemplary virtual assistant is configured to process input received through any of a plurality of modalities including but not limited to: spoken utterances, typed requests and handwritten input, among other examples. The virtual assistant may be programmed with a skill for custom search processing that adapts operation of the virtual assistant. An exemplary skill for custom search processing provides a layer of intelligence over raw application data enabling the virtual assistant (or service interfacing by a virtual assistant service) to match user input to a previous context in which a user was executing an application/service. Contextual search ranking and filtering factors in access to content and user activity when evaluating a context of a user input such as a spoken utterance. In one example, an exemplary virtual assistant is configured to enable voice-based recall for a web browser history of a user. However, exemplary processing extends to evaluate user usage data for any type of application/service, for example, to recall contextual instances where data was previously accessed through a specific application/service.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Non-limiting and non-exhaustive examples are described with reference to the following figures.

FIG. 1 illustrates an exemplary process flow for recall processing of a user input, with which aspects of the present disclosure may be practiced.

FIG. 2 illustrates an exemplary method related to personal history recall from processing of a spoken utterance, with which aspects of the present disclosure may be practiced.

FIGS. 3A-3E illustrate exemplary processing device views providing user interface examples of an exemplary virtual assistant, with which aspects of the present disclosure may be practiced.

FIG. 4 illustrates a computing system suitable for implementing processing of an exemplary virtual assistant service as well as other applications/services of a platform, with which aspects of the present disclosure may be practiced.

### DETAILED DESCRIPTION

Non-limiting examples of the present disclosure relate to personal history recall, for a received user input, through contextual analysis of user data associated with user usage of applications/services. Examples described herein extend functionality of virtual assistant applications/services, enabling a virtual assistant service to provide efficient and accurate recall processing even in instances where a user provides vague or general description. An exemplary virtual assistant is configured to process input received through any of a plurality of modalities including but not limited to: spoken utterances, typed requests and handwritten input, among other examples. The virtual assistant may be programmed with a skill for custom search processing that adapts operation of the virtual assistant. An exemplary skill for custom search processing provides a layer of intelligence over raw application data enabling the virtual assistant (or service interfacing by a virtual assistant service) to match user input to a previous context in which a user was executing an application/service. Contextual search ranking and filtering factors in access to content and user activity when evaluating a context of a user input such as a spoken utterance. In one example, an exemplary virtual assistant is configured to enable voice-based recall for a web browser history of a user. However, exemplary processing extends to evaluate user usage data for any type of application/service, for example, to recall contextual instances where data was previously accessed through a specific application/service. Exemplary skills for an exemplary virtual assistant may be programmed to extend contextual recall for any type of content. Non-limiting examples of types of content in which contextual recall may apply comprise but are not limited to: browser history, search history, file access history, image content, audio content, video content, notes content, handwritten content and social networking content, among other examples.

A virtual assistant is a software agent that can perform tasks or services on behalf of a user. Virtual assistant services operate to keep users informed and productive, helping them get things done across devices and platforms. Commonly, virtual assistant services operate on mobile computing devices such as smartphones, laptops/tablets and smart electronic devices (e.g., speakers). Real-world examples of virtual assistant applications/services include Microsoft® Cortana®, Apple® Siri®, Google Assistant® and Amazon® Alexa®, among other examples. Routine operation and implementation of virtual assistants are known to one skilled in the field of art.

In some examples, processing operations described herein may be configured to be executed by an exemplary service (or services) associated with a virtual assistant. In other examples, an exemplary virtual assistant is configured to interface with other applications/services of an application platform to enhance contextual analysis of a user input such as a spoken utterance. An exemplary application platform is an integrated set of custom applications/services operated by a technology provider (e.g., Microsoft®). Applications/services, executed through an application platform, may comprise front-end applications/services, that are accessible by customers of an application platform. Applications/service, executed through an application platform, may also comprise back-end applications/services, that may not be accessible to customers of the application platform, which are used for development, production and processing efficiency. For instance, a virtual assistant service is configured to interface with a language understanding service to provide trained language understanding processing. Results of language understanding processing may be propagated to a custom search service that enables contextual searching of user usage activity obtained through access to various applications/services (e.g., of an application platform). Contextual results, retrieved from an exemplary custom search service, may be presented through a user interface of the virtual assistant or the virtual assistant may interface to launch a representation of a contextual result in a specific application/service.

A non-limiting example of the present disclosure relates to contextual searching of a user's spoken utterance that relates to a web page previously visited while the user was utilizing a web browsing application/service. For instance, a user may ask a virtual assistant service to retrieve a web page about a real estate listing the that was viewed the previous week. Language understanding processing may be executed on the spoken utterance, where language understanding processing comprises application-specific slot tagging to assist with search of a user browser history. Language understanding processing results may be propagated to a custom search service, which executes searching of user-specific usage data (e.g., user browser history and associated log data) to contextually match an intent of a spoken utterance with previous user activity through an application/service. User-specific usage data, such as a user browser history and associated log data, may be searched to identify contextual results that match the intent of the spoken utterance. The custom search service may utilize the application-specific slot tagging to enhance contextual analysis and processing efficiency when searching the user-specific usage data. One or more contextual results are retrieved based on the searching by the custom search service. A representation of a contextual result may be generated and presented through a user interface of the virtual assistant (or another application/service). An exemplary representation of a contextual result may comprise a link (e.g., uniform resource identifier) to content that was previously accessed by the user as well as dialogue, generated through an intelligent bot, that may respond to the spoken utterance of a user. Additionally, an exemplary contextual result may comprise context relating to how specific content was accessed by the user, which may be identified from exemplary log data. This contextual data may be useful in generation of a representation of the contextual result, where a previous state of user activity may be regenerated, or such data may be useful for the virtual assistant to make recommendation/suggestions (based on previous user activity), among other examples.

Exemplary technical advantages provided by processing described in the present disclosure including but are not limited to: an ability to automate contextual recall processing that is more efficient, faster and more accurate than a user's manual attempt for recall; extending functionality of a virtual assistant to enabling contextual recall of user activity, thus providing more intelligent and capable virtual assistant services; generation of exemplary skill(s), that can be integrated with application/service such as a virtual assistant, providing contextual search operations and contextual recall of user activity; improved precision and accuracy for recall processing operations; improved processing efficiency during execution of language understanding processing as well as searching and filtering of content that matches an intent for a user input; reduction in latency in return of contextual search results for a spoken utterance; an improved user interface for exemplary applications/services (e.g., virtual assistant) that leads to improved user interaction and productivity for users through contextual recall; generation and deployment of trained machine learning modeling for contextual ranking and filtering of user-specific usage data; improved processing efficiency (e.g., reduction in processing cycles and better resource management) for computing devices executing processing operations described herein, for example, through service-based integration of resources of an application platform; improvements in accuracy and precision in interpreting a user's spoken utterance; and improved system/service examples that extend capabilities and functionality of associated applications/services, among other technical advantages.

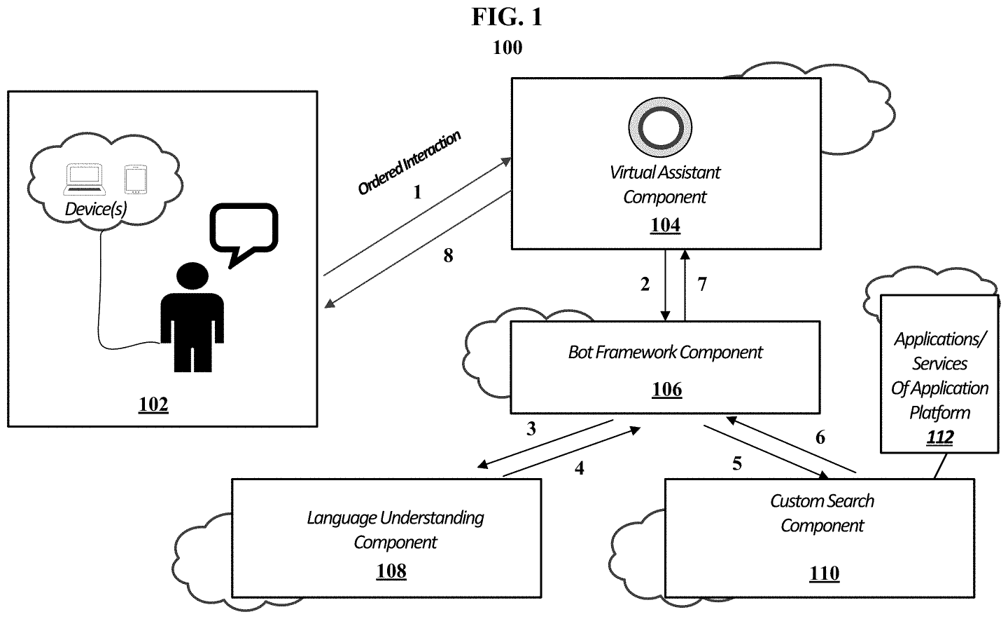

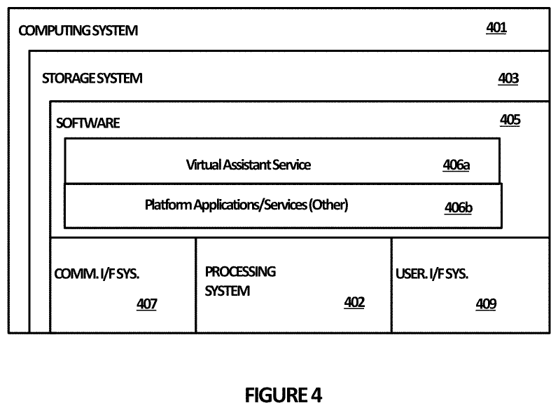

FIG. 1 illustrates an exemplary process flow 100 for recall processing of a user input, with which aspects of the present disclosure may be practiced. As an example, components of process flow 100 may be executed by an exemplary computing system (or computing systems) as described in the description of FIG. 4. Exemplary components, described in process flow 100, may be hardware and/or software components, which are programmed to execute processing operations described herein. In one example, components of process flow 100 may each be one or more computing devices associated with execution of a specific service. Exemplary services may be managed by an application platform that also provides, to a component, access to and knowledge of other components that are associated with applications/services. In one instance, processing operations described in process flow 100 may be implemented by one or more components connected over a distributed network. Operations performed in process flow 100 may correspond to operations executed by a system and/or service that execute computer programs, application programming interfaces (APIs), neural networks or machine-learning processing, language understanding processing, search and filtering processing, and generation of content for presentation through a user interface of an application/service, among other examples.

Process flow 100 comprises illustration of an ordered interaction amongst components of process flow 100. Components of process flow 100 comprise: a virtual assistant component 104, a bot framework component 106, a language understanding component 108 and a custom service component 110. Further illustrated in FIG. 1, is interaction 102 with a user computing device and applications/services 112 of an exemplary application platform. The ordered interaction, shown in FIG. 1, illustrates a flow of processing (steps labeled as 1-8) from issuance of a spoken utterance to ultimately returning, to a user computing device, a representation of a contextual result as a response for the spoken utterance. A spoken utterance is a non-limiting example of a user input, which is used for ease of understanding. It is to be understood that language understanding processing may be executed on any type of user input that is received through any type of modality without departing from the spirit of the present disclosure.

Process flow 100 begin at an interaction 102 with a user computing device (e.g., client computing device). An example of a user computing device is a computing system (or computing systems) as described in the description of FIG. 4. An interaction 102 is identified as an instance where a user provides user input through a user interface of an application/service such as a virtual assistant application/service. As identified in the foregoing, user input may comprise but is not limited to spoken utterances, typed requests and handwritten input, among other examples. An exemplary interaction 102 is the user providing a spoken utterance to an exemplary virtual assistant application/service, which is being accessed through the user computing device. For instance, a user, may activate, through action with the user computing device, an exemplary virtual assistant application/service (virtual assistant component 104) and provide a spoken utterance. As an example, the spoken utterance may be a request to retrieve data from previous user activity with the virtual assistant service or another type of application/service (e.g., associated with an application platform). Another exemplary interaction 102 is an instance where a user types a request through a chat interface of a virtual assistant (or other application/service).

A user may connect to a virtual assistant application/service through any number of different device modalities. For instance, a user may connect to an application/service (e.g., a virtual assistant service) through different computing devices, where non-limiting examples of such are: a smart phone, a laptop, a tablet, a desktop computer, etc. Each time a user accesses an exemplary application/service, log data (for a session of access) may be collected. Log data may be maintained, for a user account, across any of a plurality of computing devices that are used when a user account accessed an application/service. Exemplary log data and management of log data may occur through an exemplary custom search service component 110 and is subsequently described in that portion of the description of FIG. 1. This collective log data is searchable to identify user-specific usage data associated with an application/service.

Step 1, in the ordered interaction of process flow 100, is receipt of a user input through a virtual assistant component 104. A virtual assistant component 104 is configured to implement a virtual assistant application/service. A virtual assistant is a software agent that can perform tasks or services on behalf of a user. Virtual assistant services operate to keep users informed and productive, helping them get things done across devices and platforms. Commonly, virtual assistant services operate on mobile computing devices such as smartphones, laptops/tablets and smart electronic devices (e.g., speakers). Real-world examples of virtual assistant applications/services include Microsoft® Cortana®, Apple® Siri®, Google Assistant® and Amazon® Alexa®, among other examples. Routine operation and implementation of virtual assistants are known to one skilled in the field of art. An exemplary virtual assistant provides a user interface that is accessible to a user through the user computing device. The virtual assistant component 104 may comprise more than one component, where some of the processing for a virtual assistant service occurs over a distributed network. For instance, a spoken utterance may be received through a user interface, executing on the user computing device, and propagated to other components (of the virtual assistant or another service) for subsequent processing.

An exemplary virtual assistant is configured to interface with other applications/services of an application platform to enhance contextual analysis of a spoken utterance. An exemplary application platform is an integrated set of custom applications/services operated by a technology provider (e.g., Microsoft®). Applications/services, executed through an application platform, may comprise front-end applications/services, that are accessible by customers of an application platform. Applications/service, executed through an application platform, may also comprise back-end applications/services, that may not be accessible to customers of the application platform, which are used for development, production and processing efficiency. For instance, a virtual assistant service is configured to interface with a language understanding service to provide trained language understanding processing. Results of language understanding processing may be propagated to a custom search service that enables contextual searching of user usage data obtained through access to various applications/services (e.g., of an application platform). Contextual results, retrieved from an exemplary custom search service, may be presented through a user interface of the virtual assistant or the virtual assistant may interface to launch a representation of a contextual result in a specific application/service. As described in the foregoing description, an exemplary virtual assistant is adapted to employ a skill for custom search processing. An exemplary skill for custom search processing provides a layer of intelligence over raw application data to enable the virtual assistant to match a user input to a previous context in which a user was previously executing an application/service. Contextual search ranking and filtering factors in access to content and user activity when evaluating a context of a user input such as a spoken utterance. An exemplary skill may be programmed into executing code of the virtual assistant or be an add-on that connects to a virtual assistant application/service through an application programming interface.

Step 2, in the ordered interaction of process flow 100, is propagation of signal data associated with a user input (e.g., speech signal for a spoken utterance) that is received through the virtual assistant, to a bot framework component 106. An exemplary bot framework component 106 may be implemented for processing related to the creation and management of one or more intelligent bots to enable custom search processing that relates to user. An exemplary intelligent bot is a software application that leverages artificial intelligence to enable conversations with users. Processing operations for developing, deploying and training intelligent bots is known to one skilled in the field of art. Building off what is known, an exemplary intelligent bot may be utilized to improve natural language processing as well as enable interfacing between a virtual assistant, language understanding service and an exemplary custom search service. In some examples, a speech signal is converted to text through speech processing executed by an exemplary virtual assistant. In other instances, speech to text conversion (for subsequent processing) may occur by another application/service, for example, that may interface with the virtual assistant through an API. In one example, speech to text conversion of a speech signal is executed by a language understanding service (employed by the language understanding component 108).

The intelligent chat bot enables dialogue to be established, through an exemplary virtual assistant service, to communicate with a user when a spoken utterance is directed to recall of user-specific usage data of an application/service. An exemplary bot framework 106 is used to build, connect, deploy, and manage an exemplary intelligent bot. The bot framework 106 provides software development kits/tools (e.g., .NET SDK and Node.js SDK) that assists developers with building and training an intelligent bot. The bot framework 106 implements an exemplary software development kit that provides features, such as dialogs and built-in prompts, which make interacting with users much simpler. For example, developers can design questions, response prompts, tailoring of returned results with dialogue and any other dialogue-based flow to communicate with a user. An exemplary intelligent bot may further be utilized to define process flow for processing of a spoken utterance including interfacing with other applications/services. Furthermore, an exemplary intelligent bot may be trained to recognize patterns in speech to assist in language understanding processing.

As referenced above, the intelligent bot is employed to tailor language understanding processing for subsequent processing that searches user-specific history data of an application or service. The intelligent bot interfaces with the other components of process flow 100 to generate dialogue and process flow for dialogue processing to enable a most appropriate response to be generated for a user input. User-specific history data comprises accessed content and associated log data (detailing access to content) through an exemplary application/service. As an example, an exemplary intelligent bot is employed to tailor language understanding processing, dialog flow processing and search access to applications/services for contextual analysis of past user activity. In one instance, the intelligent bot is programmed to assist with language understanding processing such as detection of a user intent, identification of entity information and collection of application-specific parameters for search processing.

Moreover, the bot framework component 106 acts as an interface between system components such as the virtual assistant component 104, the language understanding component 108 and the custom search component 110. At various points in processing, the bot framework component 106 may receive processing from other components and propagate subsequent processing to the other components to complete the custom search process. The bot framework component 106 is utilized to convert data to a form that is usable by other applications/services. This may be accomplished through APIs, as a non-limiting example.

Step 3, in the ordered interaction of process flow 100, is forwarding of the signal associated with the user input to a language understanding component 108. As indicated in the foregoing description, the intelligent bot may be configured to enable interaction with an application/service that executes intelligent language understanding processing. An exemplary language understanding component 108 is configured to execute natural language understanding processing on a speech signal that corresponds with a spoken utterance. An exemplary language understanding component 108 uses machine learning to enable developers to build applications/services that can receive speech input and extract meaning from that speech input (or other types of user input).

Continuing an example where a user input is a spoken utterance, an exemplary language understanding component 108 is configured to implement a language understanding service to generate language understanding processing results for the spoken utterance. Traditional language understanding processing may be executed as known to one skilled in the field of art. Language understanding processing may comprise prosodic and lexical evaluation of the spoken utterance, converting the spoken utterance to text (for subsequent processing), determining an intent associated with a spoken utterance, entity identification and part-of-speech slot tagging, among other processing operations. The present disclosure further extends language understanding processing through application-specific slot tagging. Exemplary application-specific slot tagging is used to identify portions of the spoken utterance, with identifying access to data associated with an application or service. An exemplary language understanding model, implemented by a language understanding service, may be trained to execute application-specific slot tagging during language understanding processing.

Application-specific slot tagging may be used to enhance search ranking and filtering when language understanding processing results are propagated to an exemplary custom search component 110. Application-specific slot tagging is incorporated to improve processing efficiency and precision as well as reduce latency during subsequent search processing. Application-specific parameters may be defined for any application/service, where parameters that are specific to an application/service may help match an intent of a spoken utterance with recall processing. As an example, a language understanding model may be trained to identify, from a spoken utterance, parameters that comprise but are not limited to: a date range, a time range, a categorical classification of access to a uniform resource identifier (URI), a title associated with the uniform resource identifier, an amount of access corresponding with the uniform resource identifier, identification of entities in the uniform resource identifier, an indication of whether the uniform resource identifier is flagged, an indication of interaction with another user and a transactional state associated with access to the uniform resource identifier, among other examples. For instance, application-specific slot tagging may be applied to evaluate a spoken utterance that has been converted to text (speech-to-text conversion), where any of the above identified slot-tagging parameters that apply to the spoken utterance may be tagged.

Language understanding processing results may comprise data from any of the above identified processing as well as signal data associated with collection of a spoken utterance or other user input. Signal data associated with collection of a spoken utterance may comprise user data (e.g., indicating a specific user account that is signed in to a device or application/service), device data (e.g., geo-positional data, locational data, device modality) and application-specific signal data collecting from executing applications/services. With respect to application-specific signal data, an exemplary virtual assistant may collect specific signal data that is known to one skilled in the field of art. Format of language understanding processing results may vary in accordance with the knowledge of one skilled in the field of art. As a non-limiting example, a spoken utterance may be received as a hypertext transfer protocol (HTTP) request, where an exemplary language understanding model is applied to evaluate the HTTP request. In a further non-limiting example, processing, by the language understanding component 108, may create language understanding processing results in a different format such as a JavaScript object notation (JSON) object. In any example, language processing results may be generated in a format that enables applications/services to execute subsequent processing.

An exemplary application/service 112 may be any type of programmed software designed to perform a group of coordinated functions, tasks, or activities for the benefit of the user. An exemplary productivity application/service is an application/service configured for execution to enable users to complete tasks on a computing device, where exemplary productivity services may be configured for access to content including content retrieved via a network connection (e.g., Internet, Bluetooth®, infrared). An exemplary application/service provides a user interface that enables users to access content (e.g., webpages, photo content, audio content, video, content, notes content, handwritten input, social networking content). Through an exemplary application platform, a virtual assistant is configured to interface with applications/services such as productivity applications/services.

An example of an application/service 112 is a productivity application/service. Examples of productivity services comprise but are not limited to: word processing applications/services, spreadsheet applications/services, notes/notetaking applications/services, authoring applications/services, digital presentation applications/services, search engine applications/services, email applications/services, messaging applications/services, web browsing applications/services, collaborative team applications/services, digital assistant services, directory applications/services, mapping services, calendaring services, electronic payment services, digital storage applications/services and social networking applications/services, among other examples. In some examples, an exemplary productivity application/service may be a component of a suite of productivity applications/services that may be configured to interface with other applications/services associated with an application platform. For example, a word processing service may be included in a bundled service (e.g. Microsoft® Office365® or the like). Further, an exemplary productivity service may be configured to interface with other internet sources/services including third-party applications/services, for example, to enhance functionality of the productivity service.

Step 4, in the ordered interaction of process flow 100, is propagation of the language understanding processing results to the bot framework component 106. The bot framework component 106 is configured to enable interaction with exemplary custom search component 110 for searching user-specific usage data of an application/service. In step 5, in the ordered interaction of process flow 100, the bot framework component 106 propagates the language understanding processing results to the custom search component 110. The intelligent chat bot may be trained and deployed to present the language understanding results in a format that is usable by a custom search component 110.

The custom search component 110 is configured to interface with specific applications/services 112 to create a tailored search for topics that are most relevant to an intent of a user input. In one example, the custom search component 110 may be configured specifically for a single application/service (e.g., a web browsing application/service, a web search application/service, an image content management application/service). In another example, the custom search component 110 is configured to interface with a plurality of applications/services. A custom search component 110 may be configured to implement a custom search service that interfaces with other applications/services of an application platform. As an example, the custom search service may be configured to implement an API to interface with applications/services 112 to retrieve user-specific usage data and contextual results that correlate with the user-specific usage data. Exemplary contextual results comprise content that has contextual relevance to the language understanding processing results. While examples described herein reference a virtual assistant component for receipt of a user input, it is to be understood that processing by the bot framework component 106, the language understanding component 108 the custom search component 110, may be configured to work with a component providing a user interface for any type of application/service.

A targeted search result improves processing efficiency as opposed to having an application/service collect and analyze pages of general search results that may contain irrelevant content. To provide a targeted and efficient search experience, the custom search component 110 is configured to search user-specific history data of an application or service. User-specific history data comprises accessed content and associated log data (detailing access to content) through an exemplary application/service. Accessed content may be a file or specific portion of content that is accessed through an exemplary application/service. Log data may be specific to sessions of application/service usage, where the log data details user access to content and associated user activity through an exemplary application/service. Log data may be collected in accordance with privacy laws and regulations.

In examples, user-specific history data comprises aggregate log data retrieved from a plurality of computing devices that are used to access the application or service, and wherein the custom search component 110 searches the aggregate log data to retrieve the one or more contextual results. For instance, a user may connect to an application/service 112, simultaneously or at staggered times, through any number of different device modalities. For instance, a user may connect to an application/service 112 (e.g., a virtual assistant service, a web search service, a word processing service, a notes service, an image capture/processing service, an audio/music service, a social networking service) through different computing devices such as a smart phone, a laptop, a tablet, a desktop computer, etc., where log data may be collected for sessions of each computing device. The log data, across different modalities, may be aggregated for access by a custom search component 110 to provide a collective pool of log data for contextual searching. That is, a user-specific history data, that is searched, may comprise aggregate log data from access to an application/service through different device modalities of a user. Exemplary log data be stored in distributed storage(s) or databases associated with an application platform or individual application/service.

Collected log data may vary depending on the type of application/service 112. As referenced in the foregoing, application-specific slot tagging may occur during language understanding processing. Exemplary applications-specific slot tagging parameters may correspond with log data that is collected by specific applications/services 112. The application-specific slot tagging parameters may also vary depending on the type of application/service 112 that is being accessed through a custom search service. Common log data collected by applications/service is known to one skilled in the field of art. Additionally, access-based log data, that relates to access to content and user activity of with an application/service 112, may be collected. Access-based log data may comprise data including but not limited to: classification of content being accessed; interactions with other users; time spent accessing content, digital documents, specific portions of digital documents, etc., amount of access (e.g., number of times user accessed content); entity analytics related to specific content types; telemetric data regarding types of documents accessed, correlation with access to other digital documents, applications/service, etc.; specific URIs accessed; geo-locational data; indications of user actions taken with respect to specific content (e.g., flagging, bookmarking, liking/disliking, sharing, saving); and transactional states (e.g., e-commerce transactions, comparison of content/items, linking content).

The custom search component 110 (e.g., custom search service) may be configured to implement a machine learning model (or neural network model) to execute searching and filtering of contextual results. An exemplary model for searching and filtering is trained and deployed to interface with applications/services 112. Basic operations for creation, training and deployment of a machine learning model is known to one skilled in the art. In the present disclosure, an exemplary machine learning model is trained to correlate data associated with language understanding processing results, as described herein, with user-specific usage data (and associated content) that is retrieved from an application/service. In doing, so the exemplary learning model identifies contextual results of content/application data and filters the contextual results, based on relevance, for output in response to a spoken utterance. In filtering of contextual results, an exemplary learning model may execute ranking processing that executes a probabilistic or deterministic matching between the language understanding processing results and contextual results retrieved from an application/service 112. In an example where an application/service 112 being searched is a web browsing service, filtering processing may comprise retrieving visit links (e.g., URLs) from a user browser history and ranking the visited links based on a probabilistic matching with the retrieved language understanding processing results. Continuing that example, ranking processing comprises correlating the visited links and associated log data with any combination of the entities, identified in the retrieved language understanding processing results, a determined intent of a spoken utterance and results of the application-specific slot tagging.

In Step 6, in the ordered interaction of process flow 100, a contextual result is propagated from the custom search component 110 to the bot framework component 106. As an example, data associated with a contextual result may be transmitted in an HTTP request or JSON object, among types of formats. A top ranked contextual result (or N number of contextual results), from the filtering processing, may be propagated for output, through the bot framework component 106, to the virtual assistant component 104. As referenced in the foregoing, the bot framework component 106 is configured to enable interfacing between the custom search component 110 and the virtual assistant component 104. An exemplary bot framework component 106 may utilize the intelligent bot to generate dialogue that accompanies the contextual result, which may be surfaced through a user interface of the virtual assistant. An exemplary dialogue may respond to the user input (e.g., spoken utterance) as well as provide context for returning of the contextual result to the user. In doing so, the bot framework component 106 may analyze the contextual results (and associated data) to generate a most appropriate response to the user input. Generation of an exemplary dialogue is known to one skilled in the field of art. The present disclosure furthers what is known by using a context of the contextual result to craft a response to a user input such as a spoken utterance.

In Step 7, in the ordered interaction of process flow 100, the bot framework component 106 propagates the contextual result and associated dialogue to the virtual assistant component 104 for generation of a representation of the contextual result. An exemplary representation of a contextual result may comprise a link (e.g., uniform resource identifier) to content that was previously accessed by the user as well as the dialogue generated through an intelligent bot (of the bot framework component 106). Additionally, an exemplary contextual result may comprise context relating to how specific content was accessed by the user, which may be identified from exemplary log data. This contextual data may be useful in generation of a representation of the contextual result, where a previous state of user activity may be regenerated, or such data may be useful for the virtual assistant to make recommendation/suggestions (based on previous user activity), among other examples. In some instances, an exemplary representation of a contextual result may further comprise additional content portions including but not limited to: factual content, related entities, notes relating to a context in which content of the contextual result was previously accessed, a previous processing state of the content, suggested/recommended content, rich data objects, etc. which can assist a user with achieving improved productivity and processing efficiency.

In Step 8, in the ordered interaction of process flow 100, a representation of a contextual result may be generated and presented through a user interface of the virtual assistant (or another application/service). In instances where the representation is presented in an application/service other than the virtual assistant, a virtual assistant service may interface with an exemplary application/service to display the representation through that application/service. In the example where a user is requesting recall of a web page they visited through a web browser application/service, the virtual assistant may launch a web browser application/service with the recalled web page. Step 8 comprises transmission of the representation of the contextual result to the user computing device, which is called on to display the representation through the user interface of the virtual assistant. In some examples, a virtual assistant is able to utilize its other programed skills for generation a representation of a contextual result that fits in the user interface of the virtual assistant. Other programmed skills of a virtual assistant may comprise the ability to correlate related content portions and/or data types of data with a received contextual result, for example, through entity evaluation of a data associated with a contextual result.

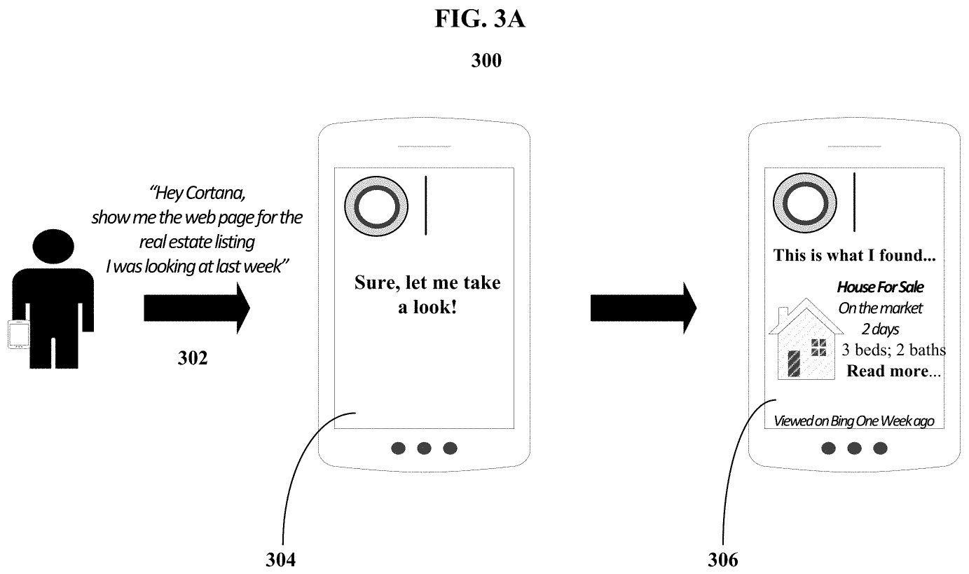

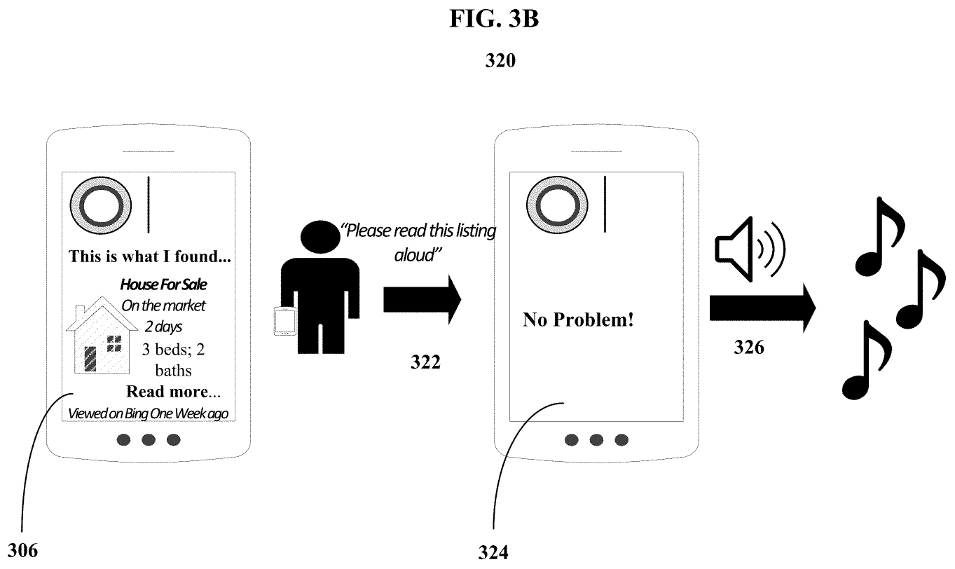

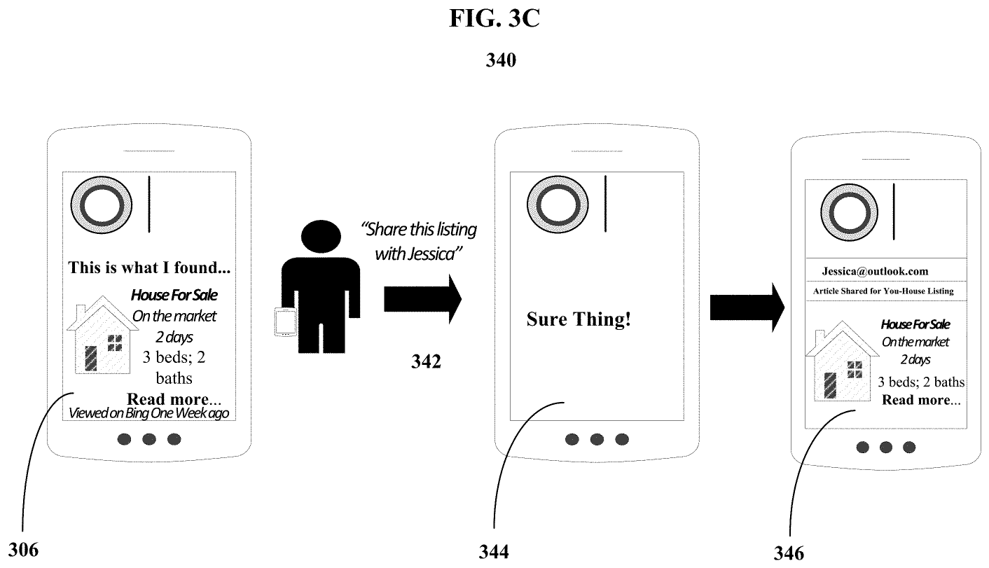

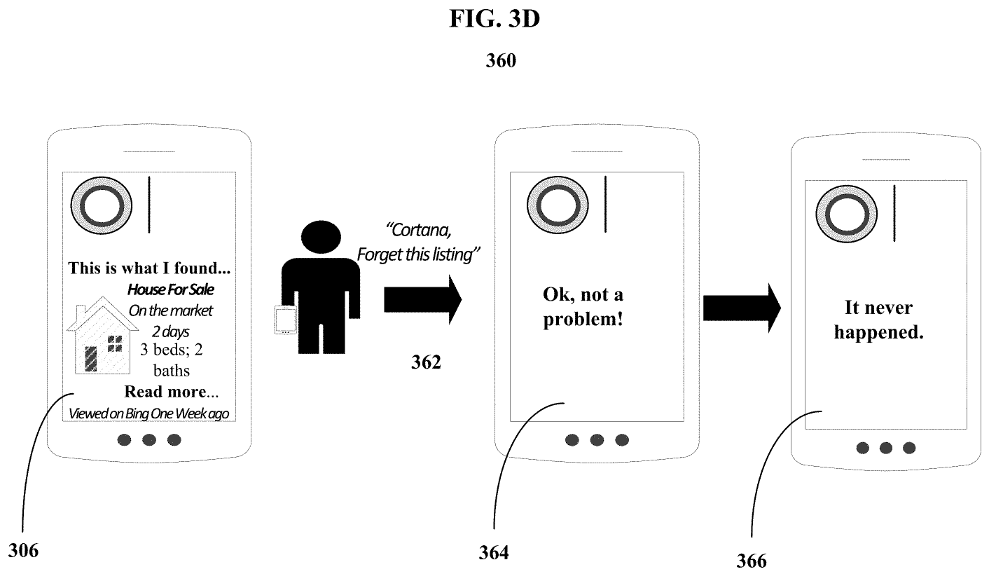

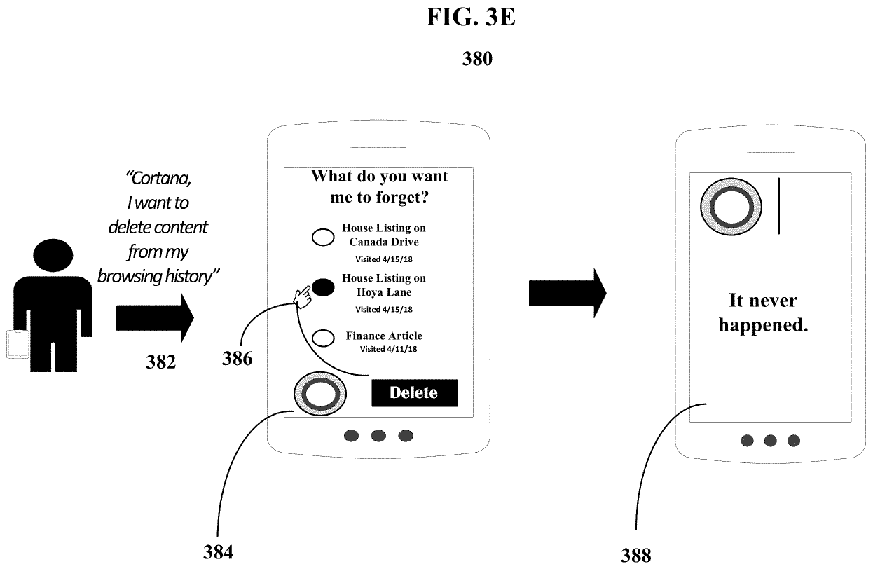

In some instances, a user may further interact with the virtual assistant, requesting additional action to be taken. For example, a user may select a content portion, provided in the representation or ask the virtual assistant for additional data or to perform a subsequent action related to provision of the representation. In such instances, the virtual assistant may continue a dialogue with a user. Additional dialogue generation and flow may occur through interaction with the intelligent bot based on the bot framework component 106 interacting with the virtual assistant. User interface examples, which include non-limiting examples of subsequent actions through a user interface of a virtual assistant, are provided in FIGS. 3A-3E. As identified in the foregoing, user input may be received in many different forms and across different modalities. In some instances, user input may comprise requests through multiple modalities, for example, where a user may initially provide a spoken utterance and then a follow-up request through a chat interface of an application/service. Processing described herein is configured to work in such examples without departing from the spirit of the present disclosure.

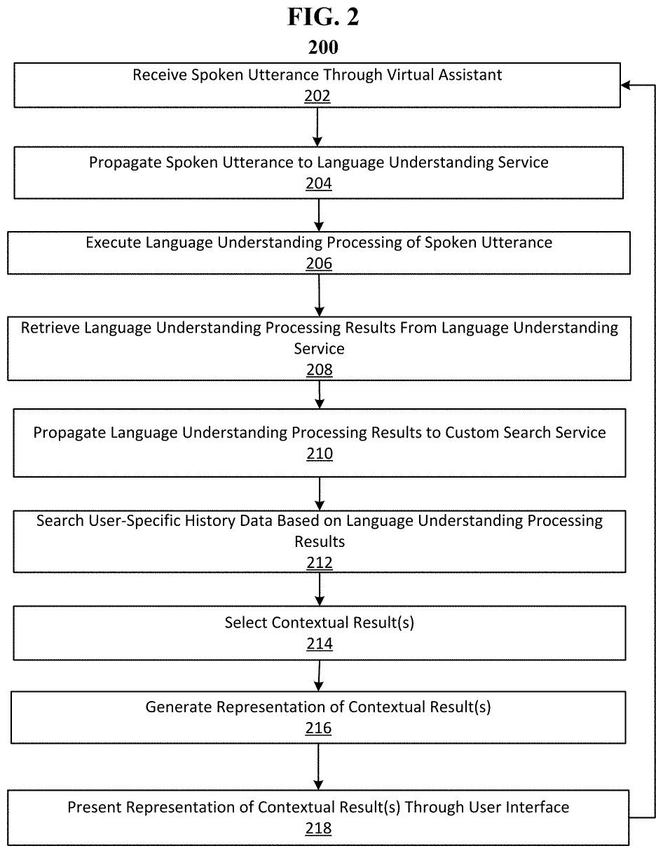

FIG. 2 illustrates an exemplary method 200 related to personal history recall from processing of a spoken utterance, with which aspects of the present disclosure may be practiced. Processing operations described in method 200 may be executed by components described in process flow 100 (FIG. 1), where the detailed description in process flow 100 supports and supplements the recited processing operations in method 200. Interfacing and communication between exemplary components, such as those described in process flow 100, are known to one skilled in the field of art. For example, data requests and responses may be transmitted between applications/services to enable specific applications/services to process data retrieved from other applications/services. Formatting for such communication may vary according to programmed protocols implemented by developers without departing from the spirit of this disclosure.

As an example, method 200 may be executed across an exemplary computing system (or computing systems) as described in the description of FIG. 4. Exemplary components, described in method 200, may be hardware and/or software components, which are programmed to execute processing operations described herein. Operations performed in method 200 may correspond to operations executed by a system and/or service that execute computer programs, software agents, intelligent bots, APIs, neural networks and/or machine-learning processing, among other examples. In some examples, processing operations described in method 200 may be executed by one or more applications/services associated with a web service that has access to a plurality of applications/services, devices, knowledge resources, etc. In one instance, processing operations described in method 200 may be implemented by one or more components connected over a distributed network.

Method 200 begins at processing operation 202, where a spoken utterance is received through a virtual assistant. An exemplary virtual assistant has been described in the foregoing description including the description of process flow 100 (FIG. 1). As an example, a spoken utterance may be received through a user interface of a virtual assistant application/service.

Method 200 continues with processing operation 204, where a spoken utterance may be propagated (or transmitted) to an exemplary language understanding service. An exemplary language understanding service may be provided by a language understanding component such language understanding component 108 described in process flow 100 (FIG. 1). In some examples, a spoken utterance may be propagated directly from a virtual assistant service. In other examples, the virtual assistant service may interface with an intelligent bot (e.g., chat bot) to enable management of dialogue flow and processing of a spoken utterance. For example, the virtual assistant service may propagate the spoken utterance to an exemplary bot framework component 106 (FIG. 1) that interfaces with a language understanding service for language understanding processing.

In processing operation 206, the language understanding service executes language understanding processing. Exemplary language understanding processing is described in the foregoing description including process flow 100 (FIG. 1). Language understanding processing results may be generated based on execution of language understanding processing by the language understanding service. Exemplary language understanding processing results have also been described in the foregoing description including process flow 100 (FIG. 1). As an example, understanding processing results comprise application-specific slot tagging parameters that may be used to identify access to data associated with an application or service. Data associated with an application/service comprises: user-specific usage data, as described in the foregoing description, as well as specific content, links (uniform resource identifiers) to the specific content.

Flow of method 200 proceeds to processing operation 208, where language understanding processing results, for the spoken utterance, are retrieved from the language understanding service. As described in process flow 100 (FIG. 1), an intelligent bot (of the framework bot component 106) may interact with an exemplary language understanding component to propagate a spoken utterance to the language understanding service. In such examples, the intelligent bot receives the language understanding processing results and propagates (processing operation 210) the language understanding processing results to a custom search service for searching and filtering processing. An exemplary custom search service is described in the foregoing description including process flow 100 (FIG. 1), where the custom search service is implemented by the custom search component 110.

An exemplary custom search service searches (processing operation 212) user-specific usage data of the application or service using the retrieved language understanding processing results. As an example, search processing may search user-specific log data, which may comprise access to an application/service by users even in instances where the user connects to the application/service through a plurality of different device modalities. Searching of user-specific log data helps to tailor a search for contextual recall as opposed to general web search retrieval.

Flow of method 200 may continue to processing operation 214, where one or more contextual results are selected. Exemplary contextual results are described in the foregoing description including the description of process flow 100 (FIG. 1). Selection (processing operation 214) of a contextual result comprises execution of filtering processing to narrow down contextual results that best match an intent of a spoken utterance (determined from language understanding processing). An exemplary custom search service is configured to execute a machine learning model (or the like) for searching and filtering processing. Filtering processing may comprise execution of machine learning ranking, to select a most contextually relevant result from candidates of contextual results. General ranking processing is known to one skilled in the field of art. An exemplary ranker, employed by the custom search service, is further extended through training. An exemplary ranker is configured to rank candidates of contextual results by matching data from the language understanding processing results with log data and associated content from usage of an application/service.

Flow of method 200 may proceed to processing operation 216. At processing operation 216, a representation of a contextual result is generated. Generation of an exemplary representation of a contextual result has been described in the foregoing description including the description of process flow 100 (FIG. 1). An exemplary representation may be generated by any of the custom search service, an intelligent bot, the virtual assistant service or a combination thereof. For example, a custom search service may retrieve content and contextual data, an intelligent bot may generate a dialogue for responding to a spoken utterance, each of which is propagated to a virtual assistant service to put those things together in an exemplary representation. As referenced in the foregoing description, an exemplary representation of a contextual result may further comprise additional content portions that may add additional context for recall of previous user activity. For example, an exemplary virtual assistant may be configured to add suggested/recommended content or provide notes indicating a previous state of access to content from the contextual analytics identified by the custom search service.

A generated representation of a contextual result may be presented (processing operation 218) through a user interface of an application/service. In one example, an exemplary representation is presented through a user interface of a virtual assistant (e.g., virtual assistant application/service). In an alternative example, an exemplary representation may be presented through a user interface of an application/service in which the contextual result was retrieved. For instance, a contextual result may comprise a previous state of access to a web page, where a representation of that contextual result comprises accessing that web page through a web browser application/service. User interface examples, which include non-limiting examples of representation of a contextual result in a user interface of a virtual assistant, are now provided in the description of FIGS. 3A-3E.

FIGS. 3A-3E illustrate exemplary processing device views providing user interface examples of an exemplary virtual assistant service, with which aspects of the present disclosure may be practiced. Processing operations described in process flow 100 (FIG. 1) and method 200 (FIG. 2) support and supplement back-end processing used for generation of exemplary processing device views shown in FIGS. 3A-3E.

FIG. 3A illustrates processing device view 300, illustrating an interaction with user, through a user computing device, and an exemplary virtual assistant application/service. An exemplary virtual assistant application/service may be accessed, by the user, through a user interface that is executing upon the user computing device. The virtual assistant may be a virtual assistant service that connects to other applications/services of an exemplary application platform over a network connection. That is, processing of a spoken utterance may occur in a system where components are connected over a distributed network.

As illustrated in processing device view 300, a spoken utterance 302 is received through a user computing device. A user may take action to launch an exemplary virtual assistant and provide the spoken utterance 302 directed to the virtual assistant. As an example, spoken utterance 302 is a request to retrieve a web page related to a real estate listing the user was viewing the previous week, where an example spoken utterance is “Hey Cortana®, show me the web page for the real estate listing I was looking at last week.”

Process device view 300 further illustrates an initial response 304 to the spoken utterance, where the initial response 304 may be dialogue indicating that the virtual assistant has received the spoken utterance and is executing processing. An exemplary initial response 304 of “Sure, let me take a look!” is returned through the user interface of the virtual assistant. This may help appease the user, for example, by visually breaking up the delay resulting from back-end processing of the spoken utterance. As an example, the initial response 304 may be generated by an exemplary intelligent bot that is interfacing with an exemplary virtual assistant. For instance, the initial response 304 may be a programmed dialogue flow that accompanies receipt of a spoken utterance.

Process device view 300 further illustrates an exemplary representation 306 of a contextual result, being a response to the spoken utterance. The exemplary representation 306 comprises content and dialogue that provides contextual recall for spoken utterance. In the example shown, the exemplary representation 306 comprises dialogue “This is what I found . . . ” as well as a rich data object providing a link to a web page (for a real estate listing) that the user was previously viewing. Additionally, the representation 306 comprises other contextual data indicating when the user viewed the web page (e.g., viewed on Bing® one week ago”). As referenced in the foregoing description, an exemplary representation may comprise other types of data/content that may further extend contextual recall for a user.

FIG. 3B illustrates processing device view 320, illustrating a continued example, from processing device view 300 (FIG. 3A), of an interaction between a user and an exemplary virtual assistant. Processing device view 320 illustrates presentation of the exemplary representation 306 of the contextual result through a user interface of the virtual assistant. The user may take subsequent action to do something with the representation 306 of the contextual result. In the example shown, the user provides a follow-up spoken utterance 322, through the user computing device, requesting that the virtual assistant execute processing to read the real estate listing aloud (“please read this listing aloud”). Processing device view 320 illustrates the provision of an initial response 324 to the follow-up spoken utterance 322, where the initial response 324 is returned through the user interface of the virtual assistant. As an example, the initial response 324 may be generated by an exemplary intelligent bot that is interfacing with an exemplary virtual assistant. For instance, the initial response 324 may be a programmed dialogue flow that accompanies receipt of a spoken utterance. The virtual assistant may be further configured to execute an action 326 that corresponds with a determined intent of the follow-up spoken utterance 322. In the example shown, the action 326 is output of an audio signal that reads aloud, for the user, details from the web page about the real estate listing.

FIG. 3C illustrates processing device view 340, illustrating a continued example, from processing device view 300 (FIG. 3A), of an interaction between a user and an exemplary virtual assistant. Processing device view 340 illustrates another non-limiting example of a subsequent action that a user might request in response to presentation of an exemplary representation 306 of the contextual result. In the example shown in processing device view 340, a user provides a follow-up spoken utterance 342, through the user computing device, requesting that the virtual assistant execute processing to share the real estate listing with another user (“share this listing with Jessica”). Processing device view 340 illustrates the provision of an initial response 344 to the follow-up spoken utterance 342, where the initial response 344 is returned through the user interface of the virtual assistant. As an example, the initial response 344 may be generated by an exemplary intelligent bot that is interfacing with an exemplary virtual assistant. For instance, the initial response 344 may be a programmed dialogue flow that accompanies receipt of a spoken utterance. The virtual assistant may be further configured to execute an action 346 that corresponds with a determined intent of the follow-up spoken utterance 342. In the example shown, the action 346 is generation of a draft message (e.g., email or SMS) that shares the web page for the real estate listing with a user (Jessica; “jessica@outlook.com”), where the user data may be retrieved from a user address book, contact list, etc., that is associated with a user account, user computing device, etc.

FIG. 3D illustrates processing device view 360, illustrating a continued example, from processing device view 300 (FIG. 3A), of an interaction between a user and an exemplary virtual assistant. In the example shown in processing device view 360, a user is requesting that the virtual assistant forget (or delete) historical usage data relating to previous user activity. An exemplary virtual assistant may be programmed with a skill to forget user-specific usage data. Traditionally, users would have to go into an application/service such as a web browser, and manually delete their browsing history. In examples of the present disclosure, an exemplary virtual assistant is configured to enable a user to initiate deletion of user-specific usage data, where the virtual assistant may interface with exemplary applications/services, which manages the user-specific usage data, and execute action for deleting such data.

In the example shown in processing device view 360, the representation 306 of the contextual result (generated in processing device view 300) is displayed. A user may provide a spoken utterance 362 that requests deletion of the web page listing (“Cortana®, forget this listing”). Processing device view 360 illustrates the provision of an initial response 364 to the spoken utterance 362, where the initial response 364 is returned through the user interface of the virtual assistant. As an example, the initial response 364 may be generated by an exemplary intelligent bot that is interfacing with an exemplary virtual assistant. For instance, the initial response 364 may be a programmed dialogue flow that accompanies receipt of a spoken utterance. The virtual assistant may be further configured to execute an action (or actions) to delete user-specific usage data related to that web page listing. In this way, the virtual assistant, and further a productivity service that tracked the user activity, may forget the web page and the context related to past user activity. Processing device view 360 illustrates a follow-up response 366, indicating to the user that the user-specific usage data is deleted.

FIG. 3E illustrates processing device view 380, illustrating an alternative example for deletion of user-specific usage data. Processing device view 380 illustrates an alternative or supplemental example to a user requesting deletion of user-specific usage data. For instance, a user may issue a spoken utterance requesting deletion of user-specific usage data, where processing of the spoken utterance may determine that further clarification of a user intent is required. In the example shown in processing device view 380, an exemplary virtual assistant may be configured to present, through its user interface, user interface (UI) features that enable a user to delete portions of user-specific usage data. While in some examples, a user may request to delete an entire browsing history or a single entry of past user activity, in other instances a user may prefer to delete (possibly in bulk) specific portions of user-specific usage data. As indicated in the foregoing, UI features for deleting user-specific usage data may also be presented for clarification of user intent.

In the example shown in processing device view 380, a user may provide a spoken utterance requesting deletion of user-specific usage data (e.g., web browsing history). Alternatively, a user may access UI features for deletion of user-specific usage data through UI features of the virtual assistant (e.g., application command control). In response to a request to delete user-specific usage data, the virtual assistant is configured to provide user interface interaction 384, which comprises UI features for deletion of specific user-specific usage data. In the example shown, a user may execute, through the user interface, an action(s) 386 that selects a specific entry of user-specific usage data (e.g., “House Listing on Hoya Lane”) and requests deletion through the UI. As a result, the virtual assistant is configured to provide a follow-up utterance 388 indicating completion of the deletion action.

FIG. 4 illustrates a computing system 401 that is suitable for implementing processing of an exemplary virtual assistant service as well as other applications/services of a platform (application platform). Computing system 401, which is representative of any system or collection of systems in which the various applications, services, scenarios, and processes disclosed herein may be implemented. Examples of computing system 401 include, but are not limited to, server computers, rack servers, web servers, cloud computing platforms, and data center equipment, as well as any other type of physical or virtual server machine, container, and any variation or combination thereof. Other examples may include smart phones, laptop computers, tablet computers, desktop computers, hybrid computers, gaming machines, virtual reality devices, smart televisions, smart watches and other wearable devices, as well as any variation or combination thereof.

Computing system 401 may be implemented as a single apparatus, system, or device or may be implemented in a distributed manner as multiple apparatuses, systems, or devices. For example, computing system 401 may comprise one or more computing devices that execute processing for applications and/or services. Computing system 401 may comprise a collection of devices executing processing for front-end applications/services, back-end applications/service or a combination thereof. Computing system 401 includes, but is not limited to, processing system 402, storage system 403, software 405, communication interface system 407, and user interface system 409. Processing system 402 is operatively coupled with storage system 403, communication interface system 407, and user interface system 409.

Processing system 402 loads and executes software 405 from storage system 403. Software 405 includes applications/service such as virtual assistant service 406a, and other applications/services 406b that associated with an application platform, which may include a language understanding service, a custom search service, a service providing a bot framework and productivity applications/services, among other examples. Software 405 is representative of the processes discussed with respect to the preceding FIGS. 1-2, including operations related to spoken utterance processing (that implements components of process flow 100 (FIG. 1) and method 200 (FIG. 2). When executed by processing system 402, software 405 directs processing system 402 to operate as described herein for at least the various processes, operational scenarios, and sequences discussed in the foregoing implementations. Computing system 401 may optionally include additional devices, features, or functionality not discussed for purposes of brevity.

Referring still to FIG. 4, processing system 402 may comprise processor, a micro-processor and other circuitry that retrieves and executes software 405 from storage system 403. Processing system 402 may be implemented within a single processing device but may also be distributed across multiple processing devices or sub-systems that cooperate in executing program instructions. Examples of processing system 402 include general purpose central processing units, graphical processing units, application specific processors, and logic devices, as well as any other type of processing device, combinations, or variations thereof.

Storage system 403 may comprise any computer readable storage media readable by processing system 402 and capable of storing software 405. Storage system 403 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or other suitable storage media, except for propagated signals. In no case is the computer readable storage media a propagated signal.

In addition to computer readable storage media, in some implementations storage system 403 may also include computer readable communication media over which at least some of software 405 may be communicated internally or externally. Storage system 403 may be implemented as a single storage device but may also be implemented across multiple storage devices or sub-systems co-located or distributed relative to each other. Storage system 403 may comprise additional elements, such as a controller, capable of communicating with processing system 402 or possibly other systems.

Software 405 may be implemented in program instructions and among other functions may, when executed by processing system 402, direct processing system 402 to operate as described with respect to the various operational scenarios, sequences, and processes illustrated herein. For example, software 405 may include program instructions for implementing an exemplary virtual assistant service 406a and/or other applications/service of an application platform 406b, as described in the foregoing description.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 405 may include additional processes, programs, or components, such as operating system software, virtual machine software, or other application software. Software 405 may also comprise firmware or some other form of machine-readable processing instructions executable by processing system 402.

In general, software 405 may, when loaded into processing system 402 and executed, transform a suitable apparatus, system, or device (of which computing system 401 is representative) overall from a general-purpose computing system into a special-purpose computing system customized to process note items and respond to queries. Indeed, encoding software 405 on storage system 403 may transform the physical structure of storage system 403. The specific transformation of the physical structure may depend on various factors in different implementations of this description. Examples of such factors may include, but are not limited to, the technology used to implement the storage media of storage system 403 and whether the computer-storage media are characterized as primary or secondary storage, as well as other factors.

For example, if the computer readable storage media are implemented as semiconductor-based memory, software 405 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 407 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

User interface system 409 is optional and may include a keyboard, a mouse, a voice input device, a touch input device for receiving a touch gesture from a user, a motion input device for detecting non-touch gestures and other motions by a user, and other comparable input devices and associated processing elements capable of receiving user input from a user. Output devices such as a display, speakers, haptic devices, and other types of output devices may also be included in user interface system 409. In some cases, the input and output devices may be combined in a single device, such as a display capable of displaying images and receiving touch gestures. The aforementioned user input and output devices are well known in the art and need not be discussed at length here.

User interface system 409 may also include associated user interface software executable by processing system 402 in support of the various user input and output devices discussed above. Separately or in conjunction with each other and other hardware and software elements, the user interface software and user interface devices may support a graphical user interface, a natural user interface, or any other type of user interface.

Communication between computing system 401 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses, computing backplanes, or any other type of network, combination of network, or variation thereof. The aforementioned communication networks and protocols are well known and need not be discussed at length here. However, some communication protocols that may be used include, but are not limited to, the Internet protocol (IP, IPv4, IPv6, etc.), the transfer control protocol (TCP), and the user datagram protocol (UDP), as well as any other suitable communication protocol, variation, or combination thereof.

In any of the aforementioned examples in which data, content, or any other type of information is exchanged, the exchange of information may occur in accordance with any of a variety of protocols, including FTP (file transfer protocol), HTTP (hypertext transfer protocol), REST (representational state transfer), WebSocket, DOM (Document Object Model), HTML (hypertext markup language), CSS (cascading style sheets), HTML5, XML (extensible markup language), JavaScript, JSON (JavaScript Object Notation), and AJAX (Asynchronous JavaScript and XML), as well as any other suitable protocol, variation, or combination thereof.

The functional block diagrams, operational scenarios and sequences, and flow diagrams provided in the Figures are representative of exemplary systems, environments, and methodologies for performing novel aspects of the disclosure. While, for purposes of simplicity of explanation, methods included herein may be in the form of a functional diagram, operational scenario or sequence, or flow diagram, and may be described as a series of acts, it is to be understood and appreciated that the methods are not limited by the order of acts, as some acts may, in accordance therewith, occur in a different order and/or concurrently with other acts from that shown and described herein. For example, those skilled in the art will understand and appreciate that a method could alternatively be represented as a series of interrelated states or events, such as in a state diagram. Moreover, not all acts illustrated in a methodology may be required for a novel implementation.

The descriptions and figures included herein depict specific implementations to teach those skilled in the art how to make and use the best option. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

Reference has been made throughout this specification to “one example” or “an example,” meaning that a particular described feature, structure, or characteristic is included in at least one example. Thus, usage of such phrases may refer to more than just one example. Furthermore, the described features, structures, or characteristics may be combined in any suitable manner in one or more examples.

One skilled in the relevant art may recognize, however, that the examples may be practiced without one or more of the specific details, or with other methods, resources, materials, etc. In other instances, well known structures, resources, or operations have not been shown or described in detail merely to observe obscuring aspects of the examples.

While sample examples and applications have been illustrated and described, it is to be understood that the examples are not limited to the precise configuration and resources described above. Various modifications, changes, and variations apparent to those skilled in the art may be made in the arrangement, operation, and details of the methods and systems disclosed herein without departing from the scope of the claimed examples.

What is claimed is:

1. A method comprising:
receiving, through a virtual assistant, a spoken utterance;
retrieving language understanding processing results for the spoken utterance;
propagating the retrieved language understanding processing results to a search service for the application or service;
searching, through the search service, user-specific history data of the application or service using the retrieved language understanding processing results;
retrieving, from the search service, one or more contextual results based on the searching of the user-specific history data; and
presenting, through a user interface of the virtual assistant, a representation of the one or more contextual results.

2. The method of claim 1, wherein the language understanding processing results comprise application-specific slot tagging that identifies parameters related to data access for data associated with an application or service, and wherein the searching searches the user-specific history data of the application or service based on results of the application-specific slot tagging.

3. The method of claim 2, wherein the application or service is a web search service, wherein the user-specific history data is a user browser history for the web search service, and wherein the one or more contextual results comprise a previously browsed web result for a user.

4. The method of claim 3, wherein the user-specific history data comprises log data associated with access to the web search service, and wherein the searching of the user-specific history data, by the search service, comprises: ranking, by applying a trained machine learning ranking model, visited links in the user browser history based on a probabilistic matching with the retrieved language understanding processing results, wherein the trained machine learning ranking model evaluates the visited links and associated log data, based entities, identified in the retrieved language understanding processing results, and results of the application-specific slot tagging.

5. The method of claim 1, wherein the user-specific history data comprises aggregate log data retrieved from a plurality of computing devices that are used to access the application or service, and wherein the search service searches the aggregate log data to retrieve the one or more contextual results.

6. The method of claim 2, wherein the retrieving of the language understanding processing results further comprises: converting the spoken utterance to text, identifying one or more entities associated with the converted text and executing part-of-speech slot tagging, and wherein the application-specific slot tagging comprises identifying, from the converted text, two or more parameters from a group that comprises: a date range, a time range, a categorical classification of access to a uniform resource identifier, a title associated with the uniform resource identifier, an amount of access corresponding with the uniform resource identifier, identification of entities in the uniform resource identifier, an indication of whether the uniform resource identifier is flagged, an indication of interaction with another user and a transactional state associated with access to the uniform resource identifier.

7. The method of claim 1, further comprising: generating a rich data object representation of the one or more context results that comprises a link to content associated with the one or more context results and one or more portions of contextually relevant data associated corresponding with the link, wherein the presenting comprises surfacing the rich data object representation as the representation of the one or more contextual results.

8. A system comprising:
at least one processor; and
a memory, operatively connected with the at least one processor, storing computer-executable instructions that, when executed by the at least one processor, causes the at least one processor to execute a method that comprises:
receiving, through a virtual assistant, a spoken utterance;
retrieving language understanding processing results for the spoken utterance;
propagating the retrieved language understanding processing results to a search service for the application or service;
searching, through the search service, user-specific history data of the application or service using the retrieved language understanding processing results;
retrieving, from the search service, one or more contextual results based on the searching of the user-specific history data; and
presenting, through a user interface of the virtual assistant, a representation of the one or more contextual results.

9. The system of claim 8, wherein the language understanding processing results comprise application-specific slot tagging that identifies parameters related to data access for data associated with an application or service, and wherein the searching searches the user-specific history data of the application or service based on results of the application-specific slot tagging.

10. The system of claim 9, wherein the application or service is a web search service, wherein the user-specific history data is a user browser history for the web search service, and wherein the one or more contextual results comprise a previously browsed web result for a user.

11. The system of claim 10, wherein the user-specific history data comprises log data associated with access to the web search service, and wherein the searching of the user-specific history data, by the search service, comprises: ranking, by applying a trained machine learning ranking model, visited links in the user browser history based on a probabilistic matching with the retrieved language understanding processing results, wherein the trained machine learning ranking model evaluates the visited links and associated log data, based entities, identified in the retrieved language understanding processing results, and results of the application-specific slot tagging.

12. The system of claim 8, wherein the user-specific history data comprises aggregate log data retrieved from a plurality of computing devices that are used to access the application or service, and wherein the search service searches the aggregate log data to retrieve the one or more contextual results.

13. The system of claim 9, wherein the retrieving of the language understanding processing results further comprises: converting the spoken utterance to text, identifying one or more entities associated with the converted text and executing part-of-speech slot tagging, and wherein the application-specific slot tagging comprises identifying, from the converted text, two or more parameters from a group that comprises: a date range, a time range, a categorical classification of access to a uniform resource identifier, a title associated with the uniform resource identifier, an amount of access corresponding with the uniform resource identifier, identification of entities in the uniform resource identifier, an indication of whether the uniform resource identifier is flagged, an indication of interaction with another user and a transactional state associated with access to the uniform resource identifier.

14. The system of claim 8, wherein the method, executed by the at least one processor, further comprises: generating a rich data object representation of the one or more context results that comprises a link to content associated with the one or more context results and one or more portions of contextually relevant data associated corresponding with the link, wherein the presenting comprises surfacing the rich data object representation as the representation of the one or more contextual results.

15. A computer storage media storing computer-executable instructions that, when executed by at least one processor, causes the at least one processor to execute a method comprising:
receiving, through a virtual assistant, a spoken utterance;
retrieving language understanding processing results for the spoken utterance;
propagating the retrieved language understanding processing results to a search service for the application or service;
searching, through the search service, user-specific history data of the application or service using the retrieved language understanding processing results;
retrieving, from the search service, one or more contextual results based on the searching of the user-specific history data; and
presenting, through a user interface of the virtual assistant, a representation of the one or more contextual results.

16. The computer storage media of claim 15, wherein the language understanding processing results comprise application-specific slot tagging that identifies parameters related to data access for data associated with an application or service, and wherein the searching searches the user-specific history data of the application or service based on results of the application-specific slot tagging.

17. The computer storage media of claim 16, wherein the application or service is a web search service, wherein the user-specific history data is a user browser history for the web search service, and wherein the one or more contextual results comprise a previously browsed web result for a user.

18. The computer storage media of claim 16, wherein the retrieving of the language understanding processing results further comprises: converting the spoken utterance to text, identifying one or more entities associated with the converted text and executing part-of-speech slot tagging, and wherein the application-specific slot tagging comprises identifying, from the converted text, two or more parameters from a group that comprises: a date range, a time range, a categorical classification of access to a uniform resource identifier, a title associated with the uniform resource identifier, an amount of access corresponding with the uniform resource identifier, identification of entities in the uniform resource identifier, an indication of whether the uniform resource identifier is flagged, an indication of interaction with another user and a transactional state associated with access to the uniform resource identifier.

19. The computer storage media of claim 16, wherein the user-specific history data comprises log data associated with access to the web search service, and wherein the searching of the user-specific history data, by the search service, comprises: ranking, by applying a trained machine learning ranking model, visited links in the user browser history based on a probabilistic matching with the retrieved language understanding processing results, wherein the trained machine learning ranking model evaluates the visited links and associated log data, based entities, identified in the retrieved language understanding processing results, and results of the application-specific slot tagging.

20. The computer storage media of claim 16, wherein the executed method further comprising: generating a rich data object representation of the one or more context results that comprises a link to content associated with the one or more context results and one or more portions of contextually relevant data associated corresponding with the link, wherein the presenting comprises surfacing the rich data object representation as the representation of the one or more contextual results.
